(19) United States
(12) Patent Application Publication
(10) Pub. No.: US 2013/0204462 A1
(43) Pub. Date: Aug. 8, 2013

(54) METHOD FOR CONTROLLED AND SAFE POWERING DOWN OF AUTONOMOUS POWER UNIT SYSTEMS USING A SUB-HERTZ PULSE-GATING TECHNIQUE

(71) Applicants: Henry A. Trujillo, Palmas, NM (US); Danny N. Ashman, Montrose (CA); Lynn M. Miner, Chewelah, WA (US); Shaun P. Ashman, Mansfield, TX (US); Brian T. Bot, Winfield (CA); Howard Ross, Montrose (CA); Roderick Swift, Walnut Creek, CA (US)

(72) Inventors: Henry A. Trujillo, Palmas, NM (US); Danny N. Ashman, Montrose (CA); Lynn M. Miner, Chewelah, WA (US); Shaun P. Ashman, Mansfield, TX (US); Brian T. Bot, Winfield (CA); Howard Ross, Montrose (CA); Roderick Swift, Walnut Creek, CA (US)

(73) Assignee: AC GLOBAL SYSTEMS LTD., Trail, BC (CA)

(21) Appl. No.: 13/579,271

(22) PCT Filed: Feb. 15, 2011
(86) PCT No.: PCT/CA2011/000152

§ 371 Date: Feb. 5, 2013

(30) Foreign Application Priority Data
Feb. 15, 2010 (GB) 1002481.8

(51) Int. Cl. G06F 17/00

(52) U.S. Cl. CPC G06F 17/00
USPC 701/2

(57) ABSTRACT

A method for powering down a autonomous power unit includes a spark ignition engine power source having an associated power source actuating system and a power output, comprises a regulator associated with the power source. The regulator comprises a deactivator actuatingly linked to the power source actuating system and having a base and secondary configurations wherein the base configuration allows the rated power output by the power source and the secondary configurations allow a progressively reduced secondary rate of power output by the power source and wherein the secondary rates are less than the base rate. The apparatus further comprises a controller remote from the regulator, for transmitting a control signal to the regulator. The deactivator is actuable in response to the control signal to activate either the base rate configuration or one of the secondary configurations to control thereby regulating the power source.

The present invention relates to the field of remote monitoring and safe over-riding control and deactivation of Autonomous Power Units whereby the Autonomous Power Unit power output can be progressively and safely reduced and controlled remotely.

There are a number of methods commercially available that are used for the remote monitoring and tracking of engines.

WO99/43513 of Ligoci and Goletas, which was published Sep. 2, 1999 discloses a vehicle disabling system; U.S. Pat. No. 6,042,678 to Muise & Thomas, issued Jun. 6, 2000 discloses a vehicle disabling system for use by pursuing law enforcement officials; U.S. Pat. No. 531,851, to Wright, issued May 17, 1994 discloses a Methane Monitor and Engine Shutdown System; U.S. application Ser. No. 12/245,321, Filed Oct. 3, 2008 discloses methods and apparatus for remotely deactivating an engine through the regulation of the air supply to its power source.

In order to enable the controlled and safe shut down of a system that comprises equipment powered by an Autonomous Power Unit, it is required that the Autonomous Power Unit is brought under control to a safe condition prior to deactivation. From the above cited works, it is well established that the complete shutdown may be accomplished; however we have determined that the element of safety, both that of the system and also that of the Autonomous Power Unit was not considered. In the case where the system is a vehicle powered by a spark ignition engine, it is not sufficient to merely turn off the engine abruptly, as this could stall the vehicle in an unsafe place such as a railroad or railway crossing or similar location where there is significant potential danger or while the vehicle is engaged in a manoeuvre which would be hazardous if the power was suddenly lost. Similarly, the abrupt halting of the engine, particularly if halted while operating at full power, could lead to potential mechanical damage, for example damage to the seals of a turbocharger, if the engine is halted in an abrupt manner.

It is therefore the object of the present invention to provide an apparatus and method to carry out the controlled shutdown of a system powered by Autonomous Power Units in such a manner as to prevent potential danger and to protect the system that is monitored and Therefore, having thus described various embodiments, at least the following is claimed:

According therefore to one aspect of the present invention, we provide apparatus for remotely controllably deactivating or partly deactivating a system, the system comprising an Autonomous Power Unit having an associated power source actuating means and a power output, the apparatus comprising a regulator associated with the system and comprising a deactivator actuatingly linked to the power source actuating means and having a base and secondary configurations wherein the base configuration allows the rated power output by the power source and the secondary configuration allows a progressively reduced rate of power output by the power source and wherein the secondary rate is less than the base rate and a controller remote from the regulator, for transmitting a control signal to the regulator, the deactivator being actuable in response to the control signal to activate one of either the base or the secondary configurations to thereby control and regulate the power source.

Preferably the power source actuating mean is a fuel supply system.

Suitably the deactivator acts independently of the fuel supply system.

Conveniently the system comprises a vehicle, the Autonomous Power Unit comprises a vehicle engine, the power source actuating means comprises a fuel supply system of the vehicle, the second configuration comprises the deactivator activating a remotely demanded gating interruption signal to the fuel delivery system to begin the slow down process thereby causing the engine to decrease horsepower output for the vehicle and the base configuration comprises the deactivator not activating the gating interruption signal to the fuel delivery system allowing the fuel delivery system to respond nominally.

Preferably the system further comprises a transmitter installed in the system, the transmitter transmitting confirmation of deactivation of the system to the controller.

Suitably the system receives a permission control signal from the controller directing the regulator to activate the system after the system has being deactivated.

According to another aspect of the present invention, we provide a method for remotely regulating power from a power source to a system comprising an Autonomous Power Unit, the Autonomous Power Unit having a power output, the method comprising regulating power to the system in such a way that the power is provided either in a primary base configuration which allows the rated power output from the power source or in at least one secondary configuration which allows a secondary rate of the power by the power source, the at least one secondary rate being less than the base rate and remotely transmitting a control signal from a controller to control the regulation of the power in either the base or the secondary configurations.

Preferably the Autonomous Power Unit comprises a vehicle, the power supply comprises a vehicle engine and a fuel delivery system, wherein in the second configuration a series of gating interruption signals are supplied to the fuel delivery system to begin a process of causing the engine to decrease horsepower output for the vehicle in a remotely controlled manner thereby to slow the vehicle down and wherein in the base configuration no gating interruption signals are supplied to the fuel delivery system thereby allowing the fuel delivery system to respond nominally and deliver the rated power output.

Suitably the system comprises a vehicle, the Autonomous Power Unit comprises a vehicle engine wherein in the secondary configuration the engine is allowed to operate for a predetermined period of time after which the engine is caused to slowdown and wherein in the base configuration the engine is allowed to operate continually.

Preferably confirmation that no gating signals are being supplied to the fuel delivery system is supplied to the controller.

Suitably a permission control signal is received from the controller to disable the system from the first and secondary configurations.

An embodiment of the invention will now be particularly described with reference to the drawings in which:

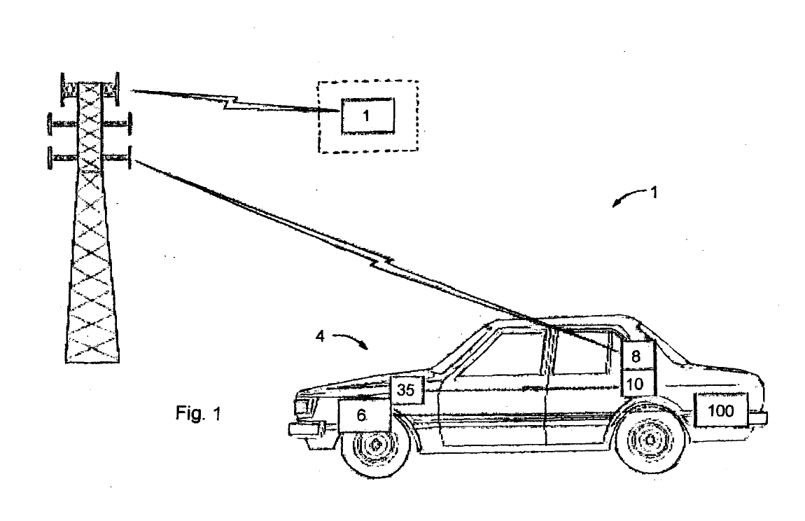

FIG. 1 is a representation of a system of a first embodiment.

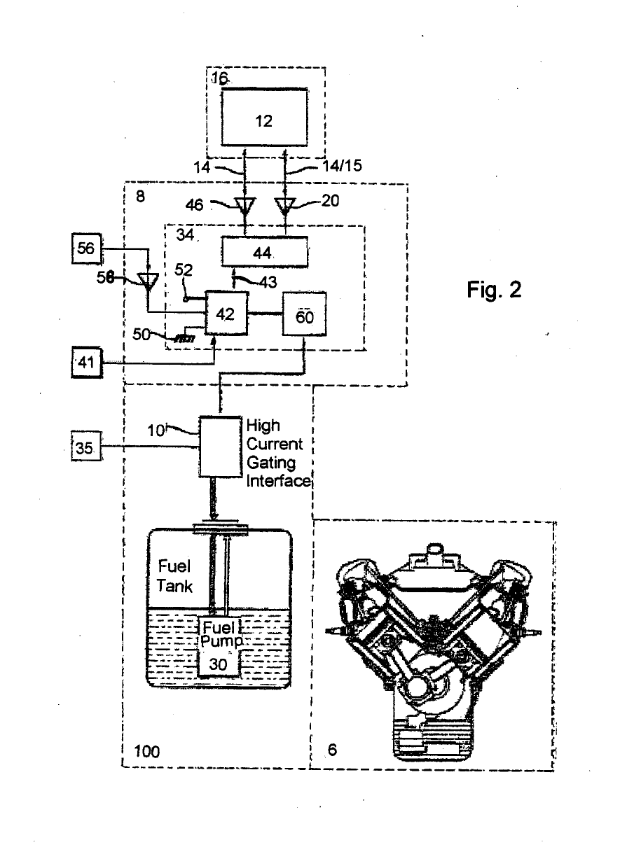

FIG. 2 is a diagram according to an embodiment.

One embodiment of the present disclosure remotely slows down, (slowdown effect), and/or disables a system where the system is a vehicle. Possible purposes of disabling the vehicle include purposes of anti-theft, anti-terrorism, anti-hijacking, security or control.

In this disclosure “system” means any possession or article having an Autonomous Power Unit, both mobile and stationary in nature. There are many possible embodiments and with suitable adjustments it may include any type of vehicle with an Autonomous Power Unit including boats, ships, cars, trucks, commercial and domestic vehicles, as well as generators, pumps and similar stationary equipment. It will be understood by those skilled in the art that some embodiments may be unsuitable for use in some types of system or in some circumstances. Those skilled in the art will be easily able to determine when to implement particular embodiments.

In this disclosure “deactivate” has its ordinary meaning and in certain embodiments may include partial and complete deactivation, disabling, shutting down, slowing, stopping, immobilizing, or down regulation. By way of example and not of limitation, where the Autonomous Power Unit is a spark ignition engine, deactivation may comprise reducing or eliminating the RPM (revolutions per minute) or power output of the engine and may be remotely controlled to be gradual or rapid or immediate and may be reversible. The choice of the most desirable levels of deactivation in given circumstances will be easily made by those skilled in the art, and will be duly activated as part of the series of reduced power alternative settings that are triggered in response to the remote monitor signals. Deactivating may comprise ending or substantially ending or limiting or partly limiting the power output from the Autonomous Power Unit and where the system is mobile then deactivation may include immobilizing the asset by the remote demand of complete cessation of power production from the Autonomous Power Unit.

“Deactivator” means a device for modulating the power output from the Autonomous Power Unit, such deactivator may comprise the normal Autonomous Power Unit regulator with additional systems added in such an manner as to provide an overriding selection of power output, or may comprise a system in parallel to the normal Autonomous Power Unit regulator, which will have the ability to negate the normal Autonomous Power Unit regulator in response to the remote monitoring system commands. A deactivator may regulate a variety of power source actuating systems associated with the power source. By way of example, the power source actuating system in a fuel injected spark ignition engine could be the fuel injector circuit. A deactivator unit is comprised by an electronic or mechanical switching system controlled by a microprocessor or other active devices suitable to regulate the activity of the power source actuating system which it controls.

“Slowdown effect” in this disclosure means reducing the Autonomous Power Unit output in order to achieve a progressive and controlled reduction in the delivered power output. For example, this would be the controlled reduction in the rolling speed of a vehicle by reducing engine horsepower. In the case of a vehicle, this could be achieved by modulating the deactivator to reduce engine horsepower by employing a remotely monitored and controlled engine control signal/power modification performed using electronic circuitry to reduce the flow (by reducing the pressure) of the fuel coming from the fuel pump to the fuel injectors of the vehicle engine or by other means. By reducing the pressure to progressively selected values, the vehicle can be slowed to a predetermined speed while allowing the vehicle to still operate under its own motive power yet not cause a hazard to the occupants or other traffic around it as it is progressively reduced in the power output available to drive the vehicle

In this disclosure, “fuel” has its ordinary meaning and is limited to petroleum, natural gas, propane, butane, methane, alcohols, diesel fuels, heavy oils, bunker fuels and kerosenes, and hydrogen and any other compounds which are suitable fuels for Autonomous Power Units.

In this disclosure, “position,” where used in reference to a deactivator, means and includes its state, condition, configuration, disposition, or status and by way of illustration and not limitation, a position may indicate configurations wherein a deactivator substantially prevents or limits the actuation of an Autonomous Power Unit.

In this disclosure, “Autonomous Power Unit” means any device for generating power by the combustion of a fuel or the use or conversion of energy either stored or delivered to the Autonomous Power Unit. In alternative embodiments a power source may be or may comprise a combustion engine which may be a spark ignition internal combustion engine or a diesel engine. Other embodiments could comprise electric motors, hydraulically powered equipment or external combustion systems such as Steam powered systems or those using the Rankin cycle or the Brayton cycle. In no manner is this disclosure limited to just these power producing systems, as it will be obvious to those skilled in the arts that this disclosure may be applied to all embodiments of Autonomous Power Units. In certain embodiments an Autonomous Power Unit may include hybrid power sources—for example, power sources that may be combinations of or alternate power sources or fuels, such as a combination of electricity and fuels, and in this case the teachings remain the same in as much as the Autonomous Power Unit may be controlled as to alter the power delivered to the power output system in essentially the same manner as a non hybrid system.

In this disclosure, “power source actuating system” means any system associated with a power source and able to influence the power output and functioning of the power source and may include but is not limited to such systems as the ignition circuit, Electronic Control Module (ECM); fuel pump circuit; fuel injector circuit. It may also include any systems associated with the asset or the power source that comprise sensors that may be connected with the power source, such as air flow sensors, emission sensors, temperature sensors, oxygen sensors, RPM sensors, hydrocarbon sensors, and a variety of others all of which will be readily apparent to those skilled in the art.

In this disclosure, “remote” or “remotely” has its normal meaning and includes such spatial relationships as apart, distant, separated, operating or controlled from a distance. Without limiting the generality of the foregoing, with respect to an asset and communication with the asset, “remote” indicates that the system is or may be separated from the controller and that communication with the system must occur at a distance, or may occur with no hard connection between the controller and the system, and may occur wirelessly through a cellular network, a satellite network, a Bluetooth network or any other suitable means of remote communication, all of which will be readily identified and implemented by those skilled in the art.

In this disclosure, “transmit” and “transmitting” means to transmit, send, forward, convey, or dispatch any form of communication signal and in certain embodiments, it may include transmission by wire, or wirelessly, including through a cellular or satellite or Bluetooth network.

A detailed explanation of control systems adaptable for the method and apparatus disclosed herein is presented in U.S. application Ser. No. 12/245,321, Filed Oct. 3, 2008 which is incorporated herein by reference in its entirety.

One embodiment of the present disclosure is generally designated 1 and is described with reference to FIGS. 1 and 2, where the figures provide representative embodiments of apparatus, systems, and methods of the present disclosure (from which other embodiments may generally follow). The embodiment of FIG. 1 comprises apparatus for remotely and controllably deactivating or partly deactivating a system 4, which may be a domestic or commercial vehicle and may be a truck. The system 4 may comprise a power source 6. The apparatus may comprise a regulator 8 associated with a system 4 and comprising a deactivator 10 having a base position and a series of secondary positions corresponding to different activation states of a power source actuating system 100. The base position may allow a rated level of power output by power source 6 and the secondary positions may allow reduced level of power output by power source 6. In some embodiments, the secondary levels may be less than the base level. The apparatus may also comprise a controller 12 remote from the regulator 8, for transmitting a control signal 14 to the regulator 8. In certain embodiments, the deactivator 10 may be actuable in response to a control signal 14 to move between the base position and the secondary positions thereby causing engine actuating system 100 to shift between different states thereby regulating the power source 6. In alternative embodiments, the controller 12 may be comprised in or may comprise a control center 16, and the regulator 8 may comprise a transmitter or receiver or transmitter receiver, all of which is generally designated 20. In one or more embodiments, the transmitter 20 may transmit the system status information 15 to the control center 16 or to controller 12 which may be comprised in or associated with control center 16. In some embodiments, the control center 16 may be or may comprise or may be associated with a fleet operations center and may be mobile or may operate through a distributed or other network and may operate through the internet.

The deactivator 10 may have a plurality of alternate positions between the base, and these secondary positions may be actuable to adopt successive positions to incrementally regulate power source 6.

In certain embodiments, the first controller 12 may also be suitable to transmit a permission signal to the regulator 8 and the movement of deactivator 10 into one of the positions may be reversible in response to, or following receipt by regulator 8 of, a permission signal from the first controller 12. In some embodiments, a plurality of systems and individual systems may be independently remotely and controllably deactivateable or partly deactivateable.

In greater detail and in particular embodiments, the regulator 8 may comprise a deactivator controller 34 closely associated with the power source 6. Deactivator controller 34 may comprise a microcontroller 42, connected to a cellular modem 44 by connection 43 and may comprise a cellular or satellite or other transceiver 20 and may comprise a GPS receiver 46.

In selected embodiments, GPS positioning may be used to track mobile systems and in embodiments a suitable GPS transceiver unit may be an A1080-A Full NMEATM GPS Unit from Tyco™ Electronics or FalcomIRMT™ or an Enfora™ modem but a range of suitable alternatives will be readily apparent to those skilled in the art. In an embodiment, the GPS receiver 46 may be integral to the modem 44.

In an embodiment, a cell phone transmitter/receiver with its antenna 20 may be integral to the modem 44. Microcontroller 42 may also have an earth 50 to the chassis of the system 4; and may have a source of power 52 which may be a 12V DC power supply. In certain embodiments, a further connection 39 may be provided to a CAN Bus monitoring device 41 which may serve to integrate response to a variety of danger signals or information inputs from the power source 6 or other sources. In some embodiments, the CAN Bus device may be a J1939\J1587.

In embodiments, activation of deactivator 10 may be provided by a handheld transmitter (keyfob) 56. Handheld transmitter signals will be received by receiver 58 processed by microcontroller 42 which than is used to activate the slowdown process.

In particular embodiments, the microprocessors of the present disclosure may be off the shelf units from Freescale Semiconductor™.

In embodiments, components for use in the apparatus may be selected to be able to operate over a wide range of temperatures as required for operation within the normal operating parameters required for service in the system, typically but not limited to, a range of from about −40° C. up to about +160° C.

As will be seen from FIG. 1 and in broad aspect, control signals 14, which may include permission signals, may be transmitted from the controller 12 of control center 16 to the system 4 and information signals 15 may be transmitted from system 4 to controller 12 of control center 16.

Such transmission may occur through the medium of a cellular network 93 as shown in FIG. 1, or through a satellite, or through any other suitable remote communications system, many of which will be readily apparent to and understood by those skilled in the art. A control signal 14 may be received by monitor 34, which passes suitable instructions to deactivator controller 60 which actuates the deactivator 10. At the system 4, the regulator 8 comprising monitor 34 and deactivator controller 60 may gather threshold information from 41 or GPS data from 44 and may transmit the information to controller 12. In embodiments, some or all of the signals between the regulator 8 and the controller 12 and/or control center 16 may be encrypted in ways that will be readily understood and applied by those skilled in the art.

A screen display may be presented through a conventional web browser. A portal display may comprise information on the status and location of the system and may comprise options for a user to remotely activate the controller 34 in a desired manner and remotely manage desired properties of the system, including its speed, activation state, and the like. Those skilled in the art will recognize that a variety of user interfaces and data displays are possible and will readily choose between and implement appropriate types.

In the event of an unauthorized use of the system 4 or any other suitable trigger event which may be determined by the user, the controller 12 may trigger deactivation of the power source 6 and hence of the system 4. In this case, the controller 12 transmits a suitable control signal to the regulator 8 which actuates the desired change in state of the deactivator 10 to cause the deactivator 10 to adopt a desired position or sequence of positions and/or configurations, such as modification/manipulation of drive signal/power relayed from 35 to a power source actuating system 100. Data regarding the progress of the deactivation process may then be transmitted back to the controller 12. Confirmation of deactivation may also be confirmed via the monitoring functions of the monitor 36 by determining position, speed time or other system status information.

An alternative embodiment of deactivator 10 also monitors vehicle speed and engine speed or torque using the vehicle CAN bus 41 and dynamically adjusts the rate of power deactivation to achieve the slowdown effort.

An alternative embodiment of the deactivator 10 also monitors vehicle speed; heading and grade change via GPS then dynamically adjust the rate of power deactivation to achieve the slowdown effort. Doing so provides a more gradual and precise reducing in fuel pressure/horsepower rather than an open loop hard gating approach.

This may be achieved by selectively reducing the power to the fuel pump within 100 or reducing the fuel flow by other means, all of which will be readily apparent to those skilled in the art. Other terminology/methodology would be a “reduction in the duty cycle” of the pump 30 or “modulation of the signal/power”, achieved in a preferred embodiment by employing a sub-hertz gating pulse for driving the fuel pump 30 by deactivator 10. Fuel delivery in the Autonomous Power Unit 6 is remote controlled. This is done via insertion of an electronic circuit 10 into the electric fuel pump drive circuitry 35 such that the fuel pump drive voltage is gated on and off at preset on and off times. This signal, once activated, gates off the fuel pump 30 to a remotely controlled manner which then progressively reduces fuel pressure within the fuel lines and starves the engine 6 reducing engine power.

Actual pressure fall rate is determined by engine type, vehicle weight, engine load, and road grade. The ability of this disclosure to select a series of deactivating conditions is aided by the monitoring which controls that before fuel line pressure reaches engine stall point, the fuel pump 6 is gated on by the deactivator 10. This action re-pressurizes the fuel line to maximum pressure. It also gives the fuel starved engine 6 enough fuel to delivery a power pulse. This is evident by a sudden momentary forward acceleration of the vehicle 6. This controlled gating off and on of the fuel pump 30 by deactivator 10 when set properly will slow the vehicle 4. It should be noted that the engine 6 is still able to operate to maintain safety features such as power steering, power brakes, etc. and other features, such as air conditioning, etc. The vehicle 4 is also able to move under its own power so as not to be stopped on rail road tracks, in heavy traffic or in an undesirable area.

In one embodiment, the circuitry 10 is inserted into the fuel pump circuit 30 to gate the fuel pump signal/power ground line. This approach is workable on either the positive side of the pump circuit or the negative (ground) side.

The above examples reduce the vehicle performance in such a way as to render a vehicle awkward to drive. Because of the controlled application of the on and off nature of controlling the fuel delivery, the system will operate in a progressively more severe low speed “jerking” motion. In terms of its intended application of anti-theft, anti-terrorism, anti-hijacking, security or control the probability of a quick “get away” or high speed chase is dramatically reduced.

The apparatus and methods disclosed can be used on all systems including mobile and stationary Autonomous Power Units engine such as generators sets, pumping systems, etc.

It will be understood that in embodiments where the system 4 is a vehicle and power source 6 is the vehicle engine, deactivation or partial deactivation of the engine results in stopping or slowing down of the vehicle 4.

Components of certain embodiments of the present disclosure can be implemented in hardware, software, firmware, or a combination thereof, such as controller logic. In some embodiment(s), components are implemented in software or firmware that is stored in a memory and that is executed by a suitable instruction execution system. If implemented in hardware, as in an alternative embodiment, the components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should also be noted that in some alternative implementations, the functions noted in the blocks of flow charts may occur out of the order noted in respective figures. For example, two blocks shown in succession may in fact be executed substantially concurrently or the blocks may sometimes be executed in the reverse order, depending upon the functionality involved, as would be understood by those reasonably skilled in the art of the present disclosure.

Executable instructions for implementing logical functions, such as controller logic, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical).

The embodiments and examples presented herein are illustrative of the general nature of the subject matter claimed and are not limiting. It will be understood by those skilled in the art how these embodiments can be readily modified and/or adapted for various applications and in various ways without departing from the spirit and scope of the subject matter disclosed and claimed. The claims hereof are to be understood to include without limitation all alternative embodiments and equivalents of the subject matter hereof. Phrases, words and terms employed herein are illustrative and are not limiting. Where permissible by law, all references cited herein are incorporated by reference in their entirety.

1. Apparatus for remotely controllably deactivating or partly deactivating a system, the system comprising an Autonomous Power Unit having an associated power source actuating system and a power output, the apparatus comprising: a regulator associated with the first system and comprising a deactivator actuatingly linked to the power source actuating system and having a base and secondary configurations wherein the base configuration allows the rated power output by the power source and the secondary configurations allows a progressively reduced rate of power output by the power source and wherein the secondary rates are less than the base rate; and a controller remote from the regulator, for transmitting a control signal to the regulator; the deactivator being actuable in response to the control signal to activate one of either the base or the secondary configurations to control thereby regulating the power source.

2. Apparatus as claimed in claim 1, wherein the power source actuating system is fuel supply system.

3. Apparatus as claimed in claim 1 or claim 2. wherein the deactivator acts independently of the fuel delivery system.

4. Apparatus as claimed in any of claims 1 to 3, wherein the system comprises a vehicle; the Autonomous Power Unit power comprises a vehicle engine; the power source actuating system comprises a fuel delivery system of the vehicle; the second configuration comprises the deactivator activating a remotely demanded gating interruption signal to the fuel delivery system to begin the slow down process thereby causing the engine to decrease horsepower output for the vehicle; and the base configuration comprises the deactivator not activating the gating interruption signal to the fuel delivery system allowing the fuel delivery system to response nominally.

5. Apparatus as claimed in claim 4 wherein a transmitter is installed in the system, the transmitter transmitting confirmation of deactivation of the system to the controller.

6. Apparatus as claimed in any of the preceding claims, wherein the system receives a permission control signal from the controller directing the regulator to activate the system after the system has being deactivated.

7. A method for remotely regulating power from a power source to a system, the method comprising an Autonomous Power Unit, the Autonomous Power Unit having a power output, the method comprising regulating power to the system in such a way that the power is provided either in a primary base configuration which allows the rated power output from the power source or in at least one secondary configuration which allows a secondary rate of the power by the power source, the at least one secondary rate being less than the base rate and remotely transmitting a control signal from a controller to control the regulation of the power in either the base or the secondary configurations.

8. A method as claimed in claim 7 wherein the Autonomous Power Unit comprises a vehicle, the power supply comprises a vehicle engine and a fuel delivery system, wherein in the second configuration a series of gating interruption signals are supplied to the fuel delivery system to begin a process of causing the engine to decrease horsepower output for the vehicle in a remotely controlled manner thereby to slow the vehicle down and wherein in the base configuration no gating interruption signals are supplied to the fuel delivery system thereby allowing the fuel delivery system to respond nominally and deliver the rated power output.

9. A method as claimed in claim 7 or claim 8 wherein the system comprises a vehicle, the Autonomous Power Unit comprises a vehicle engine wherein in the secondary configuration the engine is allowed to operate for a predetermined period of time after which the engine is caused to slowdown and wherein in the base configuration the engine is allowed to operate continually.

10. A method as claimed in either of claim 8 or 9 wherein confirmation that no gating signals are being supplied to the fuel delivery system is supplied to the controller.

11. A method as claimed in claim 10 wherein a permission control signal is received from the controller to disable the system from the first and secondary configurations.

12. Apparatus substantially as hereinbefore described with reference to any of the FIGS.

13. A method substantially as hereinbefore described with reference to any of the FIGS.
